(19) United States
(12) Patent Application Publication
(10) Pub. No.: US 2021/0059227 A1
(43) Pub. Date: Mar. 4, 2021

(54) OFF-WATER PROTECTION HEATER WITH CONTROLLER

(71) Applicant: Wen-Hong Su, Taipei City (TW)

(72) Inventor: Wen-Hong Su, Taipei City (TW)

(21) Appl. No.: 16/553,187

(22) Filed: Aug. 28, 2019

(51) Int. Cl. A01K 63/06; H05B 1/02; H05B 3/80; H05B 3/44

(52) U.S. Cl. CPC A01K 63/065; H05B 1/0202; H05B 2203/021; H05B 3/44; H05B 3/80

(57) ABSTRACT

An off-water protection heater with controller includes a controller, a tube, and a cap mounted to an end of the tube. The controller includes a control circuit and one of a relay and a TRIAC. The control circuit includes a control unit (an MCU or a comparator). The tube is provided, in an interior thereof, with an off-water protection transducer and a heating element. The off-water protection transducer is electrically connected to the control unit or is electrically connected, together with the control unit, to the one of relay and TRIAC. By using the off-water protection transducer to detect a situation of being removed out of water or not, the heating element is controlled to generate heat or not in order to ensure electricity being quickly cut off upon removal out of water thereby saving energy and preventing excessively high temperature and unloaded heating as being removed out of water.

### TECHNICAL FIELD OF THE INVENTION

The present invention provides an aquarium heater, and more particularly to an off-water protection heater with controller.

### DESCRIPTION OF THE PRIOR ART

Fishes are poikilothermal creatures. Each species of fish has specific upper and lower limits of temperature resistance as the most optimum temperature range for survival. In the most optimum temperature range, fishes demonstrate the most vivid conditions of feeding, breathing, and digesting and also show enhanced metabolism for rapid growth. When the inhabitation environments of aquariums are not properly kept in the optimum temperature range for a long term, the aquariums may suffer abnormality of metabolism, restricted growth, and even death.

People keep and raise fishes as pets all over the world. However, different areas on Earth have different weather conditions. Although indoor temperature in the summertime may be sufficient to prevent the water temperature of an aquarium tank from becoming too low, in the wintertime, the water temperature of the aquarium tank drops as varying with the indoor temperature. To maintain a comfortable vivarium condition for aquatic animals or fishes, most of the breeders provide a heater in the aquarium tank in the wintertime. Early-day heaters have evolved from traditional heaters, which require manual observation of the temperature of the aquarium tank and manual control of a switch of the heater for shutting down the heater, to electronic heater that feature automatic detection of water temperature by means of a temperature sensor and a controller element in order to timely take automatic operations of deactivation and activation.

A conventional heater includes separate controller and heating bar. Such a conventional heater may involve a control circuit that is generally one of a single-display type, a dual-display type, and a scale-based type, and may use a micro control unit (MCU) or a comparator to control the water temperature of an aquarium.

However, to date, the conventional heater of which the controller and the heating bar are separate is not provided with an off-water shutdown protection function. This often causes a situation that the aquarium heater shows extra high residual heat or improper control of water temperature may occur. For example, when the water level of an aquarium drops due to for example evaporation of water, if water is not properly supplemented, the glass tube that is operated to generate heat for heating might get broken due to excessively high temperature. This is a drawback of the conventional heater of which the controller and the heating bar are separate from each other must be improved and overcome.

### SUMMARY OF THE INVENTION

The primary objective of the present invention is to provide an off-water protection heater that prevents an excessively high heating temperature and unloaded operation as being not immersed in water or being off water.

To achieve the above objective, an embodiment of the present invention comprises a controller, a tube, and a cap mounted to an end of the tube, wherein the controller comprises, as being arranged in an interior thereof, a control circuit and one of a relay and a bidirectional triode thyristor (TRIAC), and the control circuit includes a control unit; and the tube comprises, as being arranged in an interior thereof, an off-water protection transducer and a heating element; wherein the off-water protection transducer, the control unit, the one of the relay and TRIAC, and the heating element are electrically connected in sequence to form a control loop; wherein the off-water protection transducer, upon detecting being immersed in water, transmits a signal to the control unit, and the control unit controls the one of the relay and TRIAC, according a detected temperature of water, to activate for conducting electricity to control the heating element to generate heat or not; and the off-water protection transducer, upon detecting being removed out of water, transmits a signal to the control unit, and the control unit controls the one of the relay and TRIAC to deactivate to cut off electricity so that the heating element does not generate heat so as to prevent the heater from unloaded free burning that causes breaking after removal out of water.

To achieve the above objective, another embodiment of the present invention comprises a controller, a tube, and a cap mounted to an end of the tube, wherein the controller comprises, as being arranged in an interior thereof, a control circuit and one of a relay and a bidirectional triode thyristor (TRIAC), and the control circuit includes a control unit; and the tube comprises, as being arranged in an interior thereof, an off-water protection transducer and a heating element; wherein the off-water protection transducer, the one of the relay and TRIAC, and the heating element are electrically connected in sequence to form a control loop, and the one of the relay and TRIAC is further connected to the control unit; wherein the off-water protection transducer, upon detecting being immersed in water, turns on the one of the relay and TRIAC for conducting electricity to control the heating element to generate heat; and the off-water protection transducer, upon detecting being removed out of water, turns off the one of the relay and TRIAC to cut off electricity so that the heating element does not generate heat; wherein according to a detected water temperature being higher than a preset temperature or due to an excessively high temperature resulting from removal out of water, the control unit controls the one of the relay and TRIAC to cut off electricity so that the heating element does not generate heat.

By using the off-water protection transducer to detect the situation of being removed out of water or not, the heating element is controlled to generate heat or not in order to ensure electricity being quickly cut off upon removal out of water thereby saving energy and preventing excessively high temperature of heating and also avoiding unloaded heating as being removed out of water.

### BRIEF DESCRIPTION OF THE DRAWINGS

FIG. 1 is an exploded view of the present invention.

FIG. 2 is a control logic block diagram for off-water protection according to the present invention.

FIG. 3 is a control logic block diagram for off-water protection according to another embodiment of the present invention.

### DETAILED DESCRIPTION OF THE PREFERRED EMBODIMENT

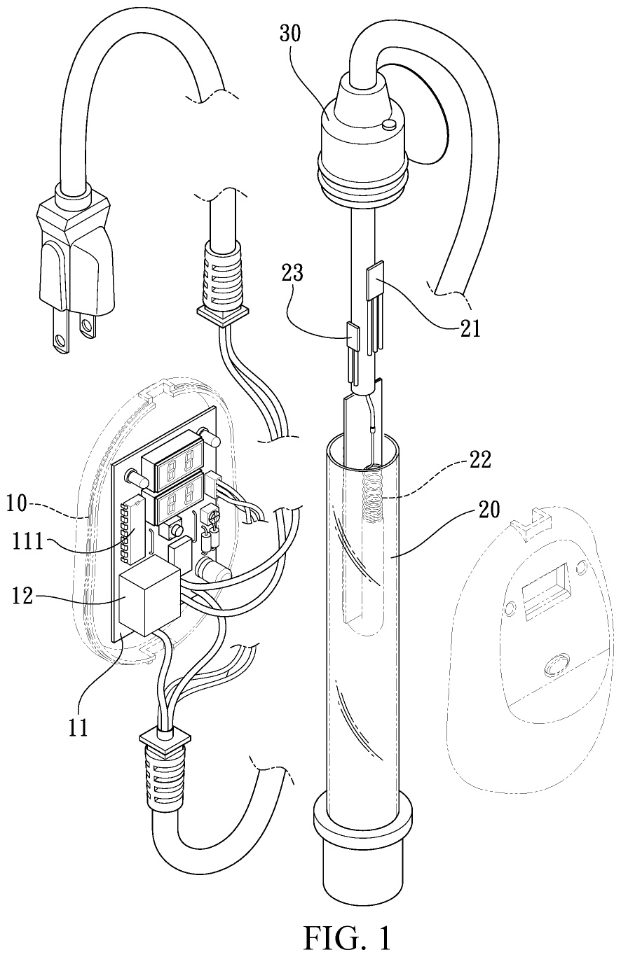

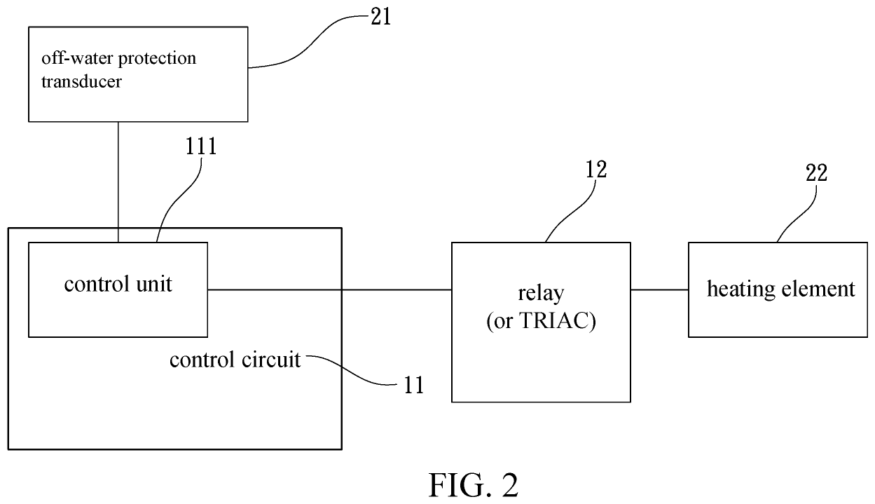

Referring to FIGS. 1 and 2, a first embodiment of the present invention is provided as follows:

An off-water protection heater with controller according to the present invention comprises a controller 10, a tube 20, and a cap 30 mounted to an end of the tube 20.

The controller 10 comprises, as being arranged in an interior thereof, a control circuit 11 and one of a relay 12 and a bidirectional triode thyristor (TRIAC) (wherein a relay 12 is shown in the drawings as an example for illustration of the embodiment, because a TRIAC provides the same function and effectiveness as the relay 12). The control circuit 11 includes a control unit 111.

The tube 20 comprises, as being arranged in an interior thereof, an off-water protection transducer 21 and a heating element 22.

The off-water protection transducer 21, the control unit 111, the one of the relay 12 and TRIAC, and the heating element 22 are electrically connected in sequence to form a control loop.

The off-water protection transducer 21, upon detecting being immersed in water, transmits a signal to the control unit 111, and the control unit 111 controls the one of the relay 12 and TRIAC, according a detected temperature of water, to activate for conducting electricity to control the heating element 22 to generate heat or not.

The off-water protection transducer 21, upon detecting being removed out of water, transmits a signal to the control unit 111, and the control unit 111 controls the one of the relay 12 and TRIAC to deactivate to cut off electricity so that the heating element 22 does not generate heat.

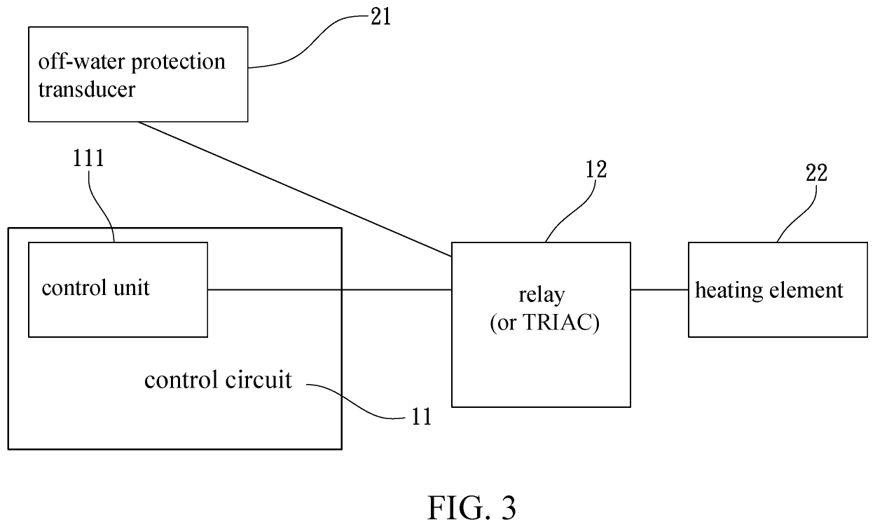

Referring to FIGS. 1 and 3, a second embodiment of the present invention is provided as follows:

An off-water protection heater with controller according to the present invention comprises a controller 10, a tube 20, and a cap 30 mounted to an end of the tube 20.

The controller 10 comprises, arranged in an interior thereof, a control circuit 11 and one of a relay 12 and a bidirectional triode thyristor (TRIAC) (wherein a relay 12 is shown in the drawings as an example for illustration of the embodiment, because a TRIAC provides the same function and effectiveness as the relay 12). The control circuit 11 includes a control unit 111.

The tube 20 comprises, arranged in an interior thereof, an off-water protection transducer 21 and a heating element 22.

The off-water protection transducer 21, the one of the relay 12 and TRIAC, and the heating element 22 are electrically connected in sequence to form a control loop, and the one of the relay 12 and TRIAC is further connected to the control unit 111.

The off-water protection transducer 21, upon detecting being immersed in water, turns on the one of the relay 12 and TRIAC for conducting electricity to control the heating element 22 to generate heat.

The off-water protection transducer 21, upon detecting being removed out of water, turns off the one of the relay 12 and TRIAC to cut off electricity so that the heating element 22 does not generate heat.

According to a detected water temperature being higher than a preset temperature or due to an excessively high temperature resulting from removal out of water, the control unit 111 controls the one of the relay 12 and TRIAC to cut off electricity so that the heating element 22 does not generate heat.

Further, the second embodiment of the present invention is generally such that for two conditions of which a first one is that the control unit 111 detects the water temperature being higher than the preset temperature or an excessively high temperature due to being moved out of water, and the second one is that when the off-water protection transducer 21 identifies a situation of being moved out of water, when either one of the two conditions is satisfied, the one of the relay 12 and TRIAC is turned off to cut off electricity so as to prevent the heating element 22 from further generating heat.

The efficacy of the present invention is that by using the off-water protection transducer 21 to detect the situation of being removed out of water or not, the heating element 22 is controlled to generate heat or not in order to ensure electricity being quickly cut off upon removal out of water thereby saving energy and preventing excessively high temperature of heating and also avoiding unloaded heating as being removed out of water.

Referring to FIG. 1, in an embodiment, the control unit 111 comprises one of a micro control unit (MCU) and a comparator.

In an embodiment, the heating element 22 is selected as one of a heating wire and a heating device.

In an embodiment, the tube 20 comprises, as being arranged therein, a thermistor 23, which transmits the detected water temperature to the control unit 111 to control the one of the relay 12 and TRIAC to turn on or not for conducting electricity.

In an embodiment, the tube 20 is selected as a glass tube.

I claim:

1. An off-water protection heater with controller, comprising a controller, a tube, and a cap mounted to an end of the tube,
wherein the controller comprises, as being arranged in an interior thereof, a control circuit and one of a relay and a bidirectional triode thyristor (TRIAC), and the control circuit includes a control unit; and
the tube comprises, as being arranged in an interior thereof, an off-water protection transducer and a heating element;
wherein the off-water protection transducer, the control unit, the one of the relay and TRIAC, and the heating element are electrically connected in sequence to form a control loop;
wherein the off-water protection transducer, upon detecting being immersed in water, transmits a signal to the control unit, and the control unit controls the one of the relay and TRIAC, according a detected temperature of water, to activate for conducting electricity to control the heating element to generate heat or not; and
the off-water protection transducer, upon detecting being removed out of water, transmits a signal to the control unit, and the control unit controls the one of the relay and TRIAC to deactivate to cut off electricity so that the heating element does not generate heat.

2. An off-water protection heater with controller, comprising a controller, a tube, and a cap mounted to an end of the tube,
wherein the controller comprises, as being arranged in an interior thereof, a control circuit and one of a relay and a bidirectional triode thyristor (TRIAC), and the control circuit includes a control unit; and
the tube comprises, as being arranged in an interior thereof, an off-water protection transducer and a heating element;
wherein the off-water protection transducer, the one of the relay and TRIAC, and the heating element are electrically connected in sequence to form a control loop, and the one of the relay and TRIAC is further connected to the control unit;
wherein the off-water protection transducer, upon detecting being immersed in water, turns on the one of the relay and TRIAC for conducting electricity to control the heating element to generate heat; and
the off-water protection transducer, upon detecting being removed out of water, turns off the one of the relay and TRIAC to cut off electricity so that the heating element does not generate heat;
wherein according to a detected water temperature being higher than a preset temperature or due to an excessively high temperature resulting from removal out of water, the control unit controls the one of the relay and TRIAC to cut off electricity so that the heating element does not generate heat.

3. The off-water protection heater with controller according to claim 1, wherein the control unit comprises one of a micro control unit (MCU) and a comparator.

4. The off-water protection heater with controller according to claim 2, wherein the control unit comprises one of a micro control unit (MCU) and a comparator.

5. The off-water protection heater with controller according to claim 1, wherein the heating element is selected as one of a heating wire and a heating device.

6. The off-water protection heater with controller according to claim 2, wherein the heating element is selected as one of a heating wire and a heating device.

7. The off-water protection heater with controller according to claim 1, wherein the tube comprises, as being arranged therein, a thermistor, which transmits the detected water temperature to the control unit to control the one of the relay and TRIAC to turn on or not for conducting electricity.

8. The off-water protection heater with controller according to claim 2, wherein the tube comprises, as being arranged therein, a thermistor, which transmits the detected water temperature to the control unit to control the one of the relay and TRIAC to turn on or not for conducting electricity.

9. The off-water protection heater with controller according to claim 1, wherein the tube is selected as a glass tube.

10. The off-water protection heater with controller according to claim 2, wherein the tube is selected as a glass tube.
